(19) United States
(12) Patent Application Publication
(10) Pub. No.: US 2009/0103073 A1
(43) Pub. Date: Apr. 23, 2009

(54) Device and method for flow state observation

(75) Inventor: Tadao Okazaki, Hamamatsu (JP)

Correspondence Address: Yokoi & Company U.S.A., INC., 13700 Marina Pointe Drive, Suite #723, Marina Del Rey, CA, 90292, US

(73) Assignee: OHM ELECTRIC CO., LTD., Hamamatsu (JP)

(21) Appl. No.: 12/316,744

(22) Filed: Dec. 16, 2008

Related U.S. Application Data
(63) Continuation-in-part of application No. 11/648,997, filed on Jan. 3, 2007.
Application No. 11/648,997 is a continuation of application No. PCT/JP2005/024074, filed on Dec. 28, 2005.

(30) Foreign Application Priority Data
Mar. 23, 2005 (JP) JP2005-083784

(51) Int. Cl. G01F 1/00

(52) U.S. Cl. 356/28; 702/49

(57) ABSTRACT

The present invention discloses a device for observing a flow state comprising a translucent duct. It further comprises an irradiation unit irradiating projection light, a condensing unit condensing the projection light along a length direction with respect to an axial core area of the translucent duct in which a fluid flows; and an image pickup unit for picking up images of scattered reflected light from the axial core area of the translucent duct at a plurality of times.

### CROSS-REFERENCE TO RELATED APPLICATIONS

This Application is a Continuation-In-Part application claiming the benefit of priority of the co-pending U.S. Utility Non-Provisional patent application Ser. No. 11/648,997, with a filing date of Jan. 3, 2007, which claims the benefit of priority of International Patent Application No. PCT/JP2005/024074, with an international filing date of Dec. 28, 2005, which designated the United States, which claims the benefit of priority of Japan Patent Application No. 2005-083784, with a filing date of Mar. 23, 2005, the entire disclosures of all Applications are expressly incorporated by reference in their entirety herein.

### BACKGROUND OF THE INVENTION

1. Field of the Invention

The present invention relates to a device and a method for flow state observations.

2. Description of Related Art

In recent years, excess supply of lubricating oil has been identified as an issue or impediment in achieving and producing zero emissions in machining plants.

Previous attempts to meet such a need established a minute or small flow path for oil to attempt an increase in the flow rate, and measured the duct resistance as a pressure difference. However, with this conventional technique, correction of the fluid viscosity is necessary because fluid viscosity fluctuates markedly with respect to temperature. In addition, the technique introduces a further complication with respect to possible blockage of the flow path due to the smaller flow path size. It should further be noted that the supply of a minute or small flow volume is generally implemented by intermittently driving a driving element such as a diaphragm or valve in a pump or the like. The intermittently driven driving element makes the flow state complex because the flow state microscopically depends on when the driving element is operational and when the driving element is stopped. Accordingly, determining the complex flow state of a fluid of a minute or small volume is also complex, and observation of this type of flow state is difficult. Finally, this technique is mostly confined to the experimental stages of devices and does not satisfy the requirements for Factory Automation (FA) site measurement tools.

Therefore, there exists a need for robust measurement tools, with a resolution of approximately 10 μL (liters)/h or better, for the purpose of quantitatively grasping and managing the supply of lubricating oil for machinery and the like.

### BRIEF SUMMARY OF THE INVENTION

The present invention discloses a device for observing a flow state, comprising: a translucent duct; an irradiation unit irradiating projection light; a condensing unit condensing the projection light along a length direction with respect to an axial core area of the translucent duct in which a fluid flows; and an image pickup unit for picking up images of scattered reflected light from an axial core area of the translucent duct at a plurality of times.

These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding part(s) throughout:

FIG. 1 is an exemplary schematic diagram of a flow state observation device in accordance with an embodiment of the present invention;

FIG. 2 is an exemplary perspective view of a few of the components of the flow state observation device of FIG. 1;

FIG. 3A is an exemplary graph showing an exemplary distribution of a flow rate of oil-air mixture within the flow state observation device of FIG. 1;

FIG. 3B is an exemplary schematic diagram that superimposes the graph of FIG. 3A with the flow state observation device of FIG. 1;

FIG. 4 is an exemplary schematic diagram of an observed image of a flow state observation device of FIG. 1;

FIG. 5 is an exemplary flowchart for analyzing a time frequency of evaluation values in accordance with an embodiment of the present invention;

FIG. 6 is an exemplary schematic diagram depicting weighting functions used in accordance with an embodiment of the present invention;

FIG. 7 is an exemplary schematic diagram showing time frequency of the evaluation values in accordance with an embodiment of the present invention;

FIG. 8 is an exemplary block diagram of the flow state observation device in accordance with another embodiment of the present invention;

FIG. 9 is an exemplary output example of image pickup images that are arranged to permit a comparison in accordance with one embodiment of the present invention;

FIG. 10 is an exemplary block diagram of the essential parts of the flow state observation device in accordance with yet another embodiment of the present invention;

FIG. 11 shows an exemplary aspect in which the image pickup images are moved;

FIG. 12 is an exemplary graph showing a spatial frequency spectral in accordance with the present invention; and

FIG. 13 is an exemplary graph showing a correlation coefficient in accordance with the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

For purposes of illustration, programs and other executable program components are illustrated herein as discrete blocks, although it is recognized that such programs and components may reside at various times in different storage components, and are executed by the data processor(s) of the computers.

Further, each block within flowcharts may represent a method function(s), operation(s), or act(s) and one or more elements for performing the method function(s), operation(s), or act(s). In addition, depending upon the implementation, the corresponding one or more elements may be configured in hardware, software, firmware, or combinations thereof

### (A) First Embodiment

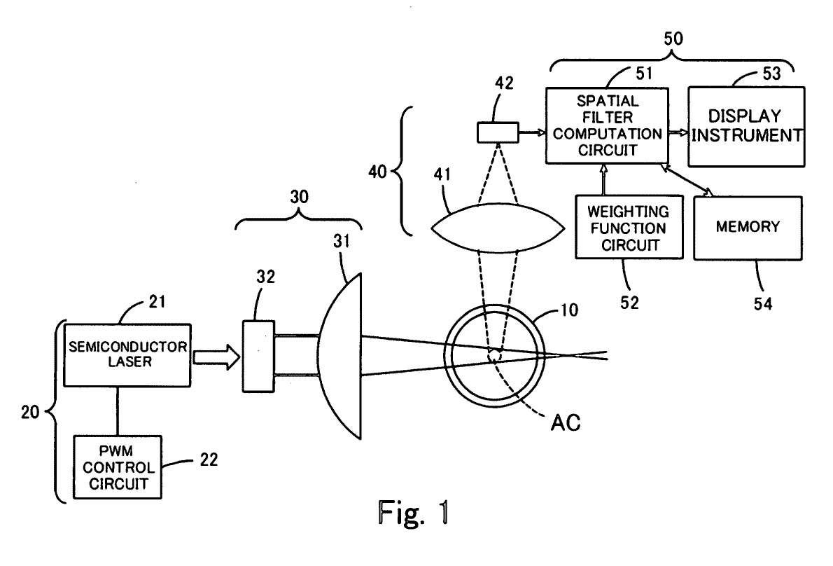

FIG. 1 is an exemplary block diagram of a flow state observation device 1 in accordance with a first embodiment. The flow state observation device 1 is comprised of a translucent duct 10, a semiconductor laser 21, a PWM (Pulse Width Modulation) control circuit 22, a cylinder lens 31, a concave lens 32, a second optical system 41, a CCD (Charge Coupled Device) line sensor 42, and a spatial filter computation means 50.

The semiconductor laser 21 irradiates projection light of a predetermined intensity as a result of a driving power supply being supplied by a PWM control circuit 22. The semiconductor laser 21 is made of a semiconductor laser diode. An intensity of the projection light can be adjusted by the PWM control circuit 22 that controls a duty ratio between a light emission time and a light extinction time.

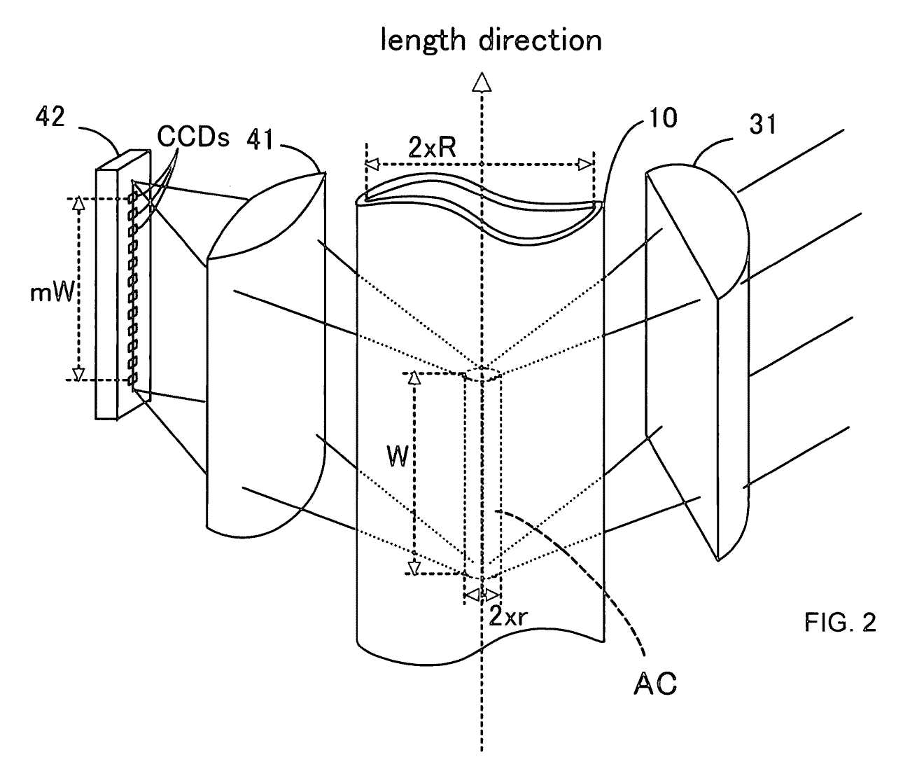

FIG. 2 is an exemplary perspective view partially showing an arrangement of the translucent duct 10, the cylinder lens 31, the second optical system 41, and the CCD line sensor 42. The translucent duct 10 is formed in a substantially cylindrical configuration, having an axial length that is parallel along a longitudinal axis thereof, and is comprised of transparent glass. The translucent duct 10 has a substantially circular cross section that is perpendicular to a length direction (an axial core direction) of the translucent duct 10, with an inner diameter “2×R,” with R representing the radius of the substantially circular cross-section.

In the present invention, oil particles mixed with air as “oil-air” mixture flow through the translucent duct 10 and, therefore, the translucent duct 10 is not filled (or saturated) with oil, but includes a mixture of oil and air. With this exemplary first embodiment, the oil-air mixture flows along the length direction of the translucent duct 10 having a flow state that can be considered or characterized as a laminar flow.

An axial core area AC is provided in the center of the translucent duct 10. The axial core area AC is defined in a cylindrical shape that is coaxial to the translucent duct 10. That is, the axial core area AC and the translucent duct 10 have a common center axis. The axial core area AC has a length W along the length direction of the translucent duct 10. The axial core area AC has a diameter “2×r,” with r representing the radius of the circular cross-section of the substantially cylindrical axial core area AC. The diameter “2×r” is equivalent to 10% of the inner diameter “2×R” of the translucent duct 10.

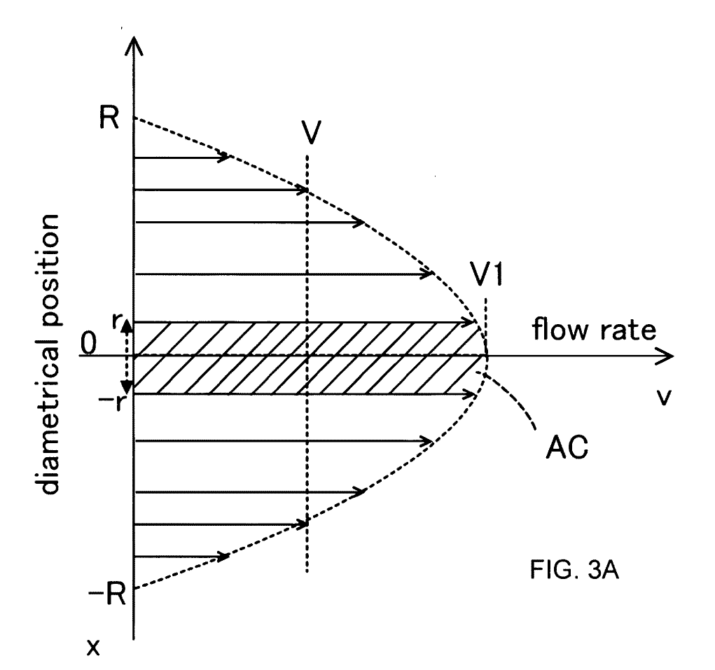

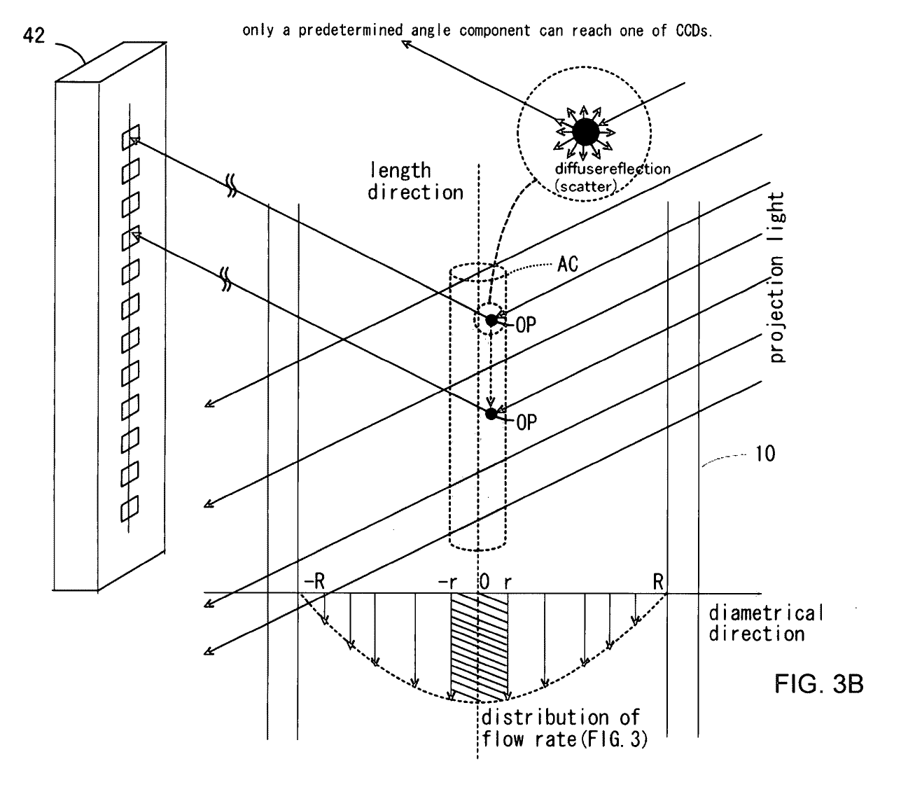

FIG. 3A is an exemplary graph showing a distribution of a flow rate v of the oil-air mixture along the diametrical direction of the translucent duct 10. A vertical axis of the graph indicates a diametrical position x (−R≦x≦R) including a center position (x=0) of the translucent duct 10, with a horizontal axis indicated as a magnitude of the flow rate v at each of the diametrical positions x.

As shown in FIGS. 3A and 3B, the flow rate has a substantially parabolic distribution because the oil-air mixture is considered to have a laminar flow. The flow rate v in the axial core area AC is represented by a core flow rate V1, and an average value of the flow rate v is represented by an average flow rate V. The core flow rate V1 can be considered as a constant value because the core flow rate V1 is near to a peak of the distribution, where a gradient is substantially equivalent to 0. That is, all of the oil particles OP flowing in the axial core area AC substantially have a uniform core flow rate V1, which is not dependent on the diametrical positions x. A range of the core flow rate V1 is between “1.98×V” and “2×V” because of the substantially parabolic distribution. That is, the average flow rate V is substantially equivalent to a half of the core flow rate V1.

As best illustrated in FIGS. 2, 3A, and 3B, the cylinder lens 31 and the concave lens 32 (shown in FIG. 1) provide an optical path to condense the projection light that is irradiated by the semiconductor laser 21 into the axial core area AC. The projection light irradiated by the semiconductor laser 21 is condensed within the diameter “2×r” of the axial core area AC. On the other hand, the projection light irradiated by the semiconductor laser 21 is expanded within the length W along the length direction in the axial core area AC. Accordingly, the axial core area AC is entirely projected by the projection light irradiated by the semiconductor laser 21.

Light axes of the second optical system 41 and the cylinder lens 31 cross at a predetermined acute angel (between 0° and 90° degrees). The second optical system 41 has an optical magnification m along the length direction W of the axial core area AC. The CCD line sensor 42 is a line sensor having a plurality of CCDs. The CCDs are linearly placed within a predetermined range having length equivalent to “m×W” to detect the entire core image of the axial core area AC. The CCDs are periodically placed with a constant spatial pitch p. The spatial pitch p provides a discrete rather than a continuous periodic detection. As illustrated in FIGS. 2 and 3B, each of the CCDs detects light emanating from the axial core area AC and generates electric charge corresponding to the received light intensity. Therefore, the resulting line image of the axial core area AC detected by the CCD line sensor 42 is discrete.

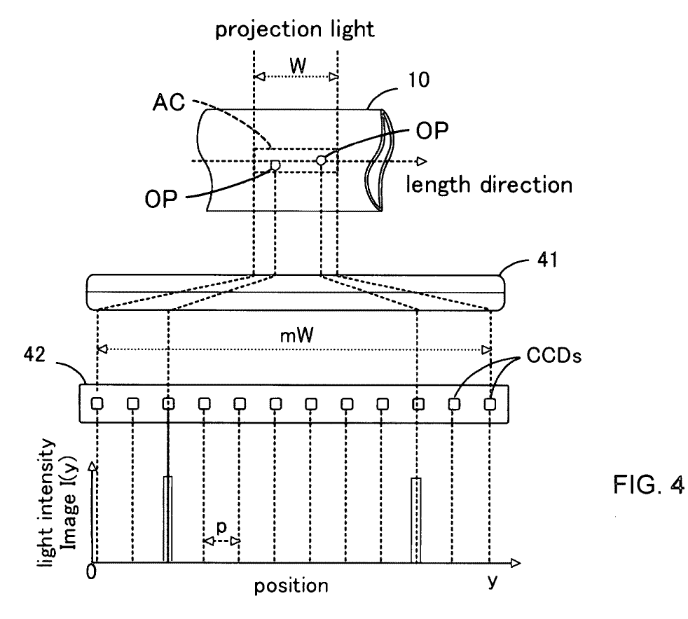

FIG. 4 is an exemplary schematic diagram of the image I(y) detected by the CCD line sensor 42. The illustrated horizontal axis represents a position y corresponding to each of the CCD positions or placements, and the illustrated vertical axis represents the electric charges of the CCDs. The image I(y) can be considered as a discontinuous function of the position y. The image I(y) is comprised of pixels that have the digital tones corresponding to the electric charges (the light intensity) of the CCDs.

As best illustrated in FIGS. 3B and 4, the projection light irradiated by the semiconductor laser 21 may straightly penetrate the translucent duct 10 and the oil-air mixture therein. The projection light from the semiconductor 21 straightly penetrating the translucent duct 10 cannot be introduced to the second optical system 41 because the light axes of the second optical system 41 and the concave lens 32 cross at a predetermined acute angel. When no particles exist within the axial core area AC, all projection light straightly penetrates through the translucent duct 10 and no light is introduced to the second optical system 41. Accordingly, the image I(y) does not have the light intensity other than 0 at any position y.

On the other hand, as further illustrated in FIGS. 3B and 4, if one or more of the oil particles OP are flowing (existing) in the axial core area AC, fractions of the projection light are scattered and reflected off of the oil particles OP as illustrated in FIGS. 3B and 4. The oil particles OP have a refractive index that is different from that of the air, and therefore, the projection light is scattered into the predetermined acute angle, and is introduced into the second optical system 41. The positions y of the CCDs geometrically correspond to the length position in the axial core area AC, with the magnification m. Therefore, the length position, where the oil particle OP exists, can be specified by the image I(y).

Further, in case of one or more oil particles flowing along the length direction with a constant core flow rate V1, each CCD detects the scattered projected light reflected from the oil particles OP as they move along the translucent duct 10, and their respective light reflection comes within the detection range of an CCD. That is, each individual CCD detects a projected light reflected from the oil particle as the reflected light of the oil particles moves through the detecting “domain or territory” of the CCD. Given the spatial pitch P of the distance between each individual CCD, the detection will be periodic. A time frequency F when one of the CCDs detects the projection light should correspond to the core flow rate V1. That is, the core flow rate V1 can be specified by analyzing the time frequency F of a fluctuation of receiving light intensity according to the image I(y). The image I(y) can be acquired by the spatial filter computation means 50.

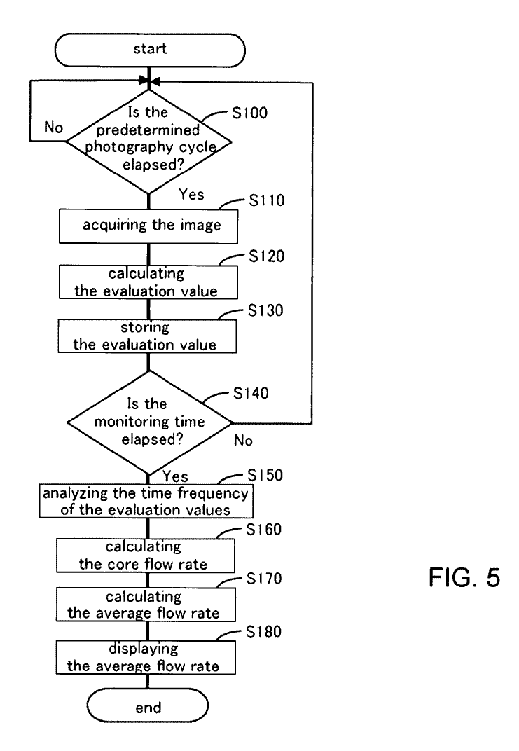

For analyzing the time frequency F, the spatial filter computation means 50 performs an analysis process shown in FIG. 5. The spatial filter computation means 50 are comprised of a spatial filter computation circuit 51, a weighting function circuit 52, a display instrument 53, and a memory 54.

As illustrated in FIG. 5, in operational act S100, the spatial filter computation means 50 determines if a predetermined photography cycle is elapsed. A predetermined photography cycle may be construed as the time period within which a CCD acquires or captures an image. If the predetermined photography cycle is not elapsed, the spatial filter computation means 50 repeats the operational act S100 (waits until the predetermined photography cycle is elapsed). If the predetermined photography cycle is elapsed, the spatial filter computation means 50 make the CCD line sensor 42 pickup the image I(y) and the spatial filter computation means 50 acquires the image I(y) in the operational act S110. That is, the image I(y) is time-periodically acquired by the spatial filter computation means 50.

In the operational act S120, the spatial filter computation circuit 51 calculates an evaluation value E, exemplarily represented by Equation 1.

$$E = {\int }_{0}^{mW} W ( y ) I ( y ) d y \qquad ( Equation 1 )$$

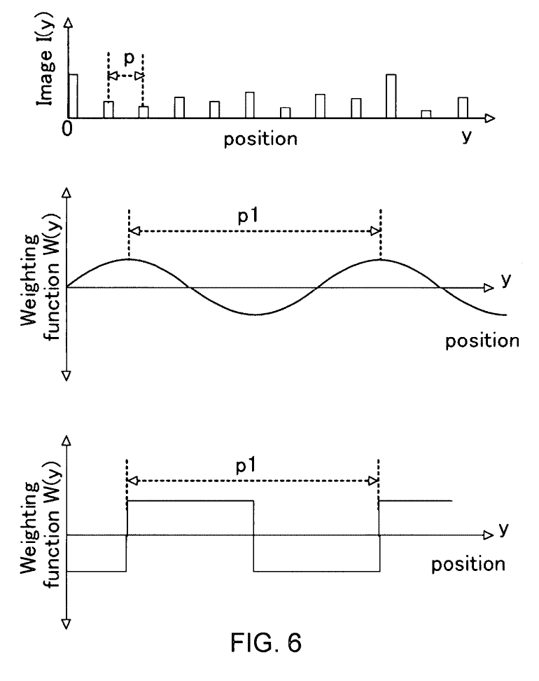

FIG. 6 is a schematic diagram explaining a weighting function W(y) in accordance with the present invention. In this embodiment, the weighting function W(y) is an exemplary sine function of the position y with a constant spatial period (a spatial pitch p1) along the length direction (the direction where the CCDs are placed). The spatial pitch p1 should be bigger than the spatial pitch p where the CCDs are periodically placed. In this embodiment, the spatial pitch p1 of the weighting function W(y) is equivalent to about 8 times of the spatial pitch p of the CCDs. According to Equation 1, the evaluation value E is calculated by a convolution between the weighting function W(y) and the images I(y), with an integral interval of Equation 1 corresponding with the length W of the axial core area AC in order to evaluate the entire axial core area AC.

As illustrated in FIG. 2, the weighting function W(y) is provided by the weighting function circuit 52. The spatial pitch p1 of the weighting function W(y) is adjusted by the weighting function circuit 52. The larger the axial core flow rate V1 is estimated, the larger the spatial pitch p1 of weighting function W(y) is adjusted. The axial core flow rate V1 can be estimated based on, for example, a power of a pump that is pumping the oil-air mixture in the translucent duct 10. In addition, other kinds of functions can be applied for the weighting function W(y) so long as the functions has the constant spatial pitch p1. For example, a Hanning function and a rectangular wave function (shown in FIG. 6) can be used as the weighting function W(y). The CCD line sensor 42 has a fixed spatial pitch p1. However, a spatial selectivity according to the CCD line sensor 42 can be adjusted by multiplying the weighting function W(y). That is, the weighting function W(y) with an adjustable spatial pitch p1 is functioning as a spatial frequency filter.

Referring back to FIG. 5, in operational act S130, the spatial filter computation circuit 51 stores the evaluation value E in the memory 54. In operational act S140, the spatial filter computation means 50 determines if a monitoring time is elapsed. The monitoring time should be larger than the predetermined photography cycle. If the monitoring time is not elapsed, the spatial filter computation means 50 returns to the operational act S100. Therefore, the evaluation values E at each of the predetermined photography cycles can be repeatedly calculated and stored in the memory 54 until the monitoring time is elapsed. If the monitoring time is elapsed, the spatial filter computation means 50 executes the operational act S150. In the operational act S150, the spatial filter computation means 50 analyzes the time frequency F of the evaluation values E stored in the memory 54.

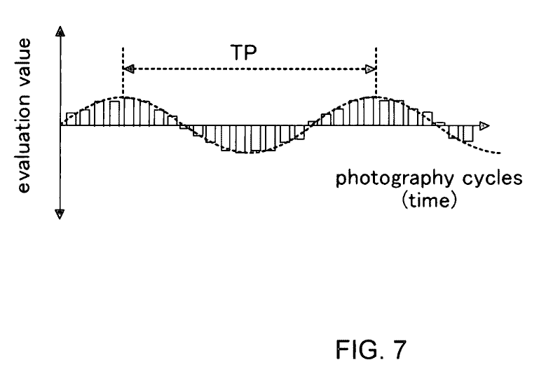

In FIG. 7, a horizontal axis represents the time of each of the predetermined photography cycles, and a vertical axis represents magnitudes of the evaluation values E for each corresponding photographic cycle. Therefore, each individual evaluation value E represented in FIG. 7, is obtained after the full loop in FIG. 5, from operational acts S100 to S140. In the operational act S150, the spatial filter computation means 50 detects wavelike fluctuations of the evaluation values E and measures the time frequency F (inverse value of a time period “TP”) of the wavelike fluctuations. Frequency analysis technique such as the commonly known FFT (Fast Fourier Transform) can be used for analyzing the time frequency F. It should be noted that the fluctuations of the evaluation values E contain a plurality of waveforms with individual phases according to a plurality of the oil particles OP. However, the time frequency F can be easily found by the FFT. In addition, only one value of time frequency F can be found, because all of the oil particles OP flowing in the axial core area AC substantially have the uniform value of the core flow rate V1.

In operational act S160, the spatial filter computation means 50 calculates the core flow rate V1 based on Equation 2.

V1=p1×F/m (Equation 2)

According to Equation 2, the core flow rate V1 can be calculated by dividing a multiplication value between the spatial pitch p1 and the time frequency F by the optical magnification m of the second optical system 41.

In operational act S170, the spatial filter computation means 50 calculates the average flow rate V based on Equation 3.

V=V1/2 (Equation 3)

According to Equation 3, the average flow rate V can be calculated by dividing the core flow rate V1 by 2. As explained with FIG. 3, the average flow rate V is substantially equivalent to a half of the core flow rate V1. In operational act S180, the display instrument 53 such as a LCD (Liquid Crystal Display) displays the average flow rate V.

### (B) Second Embodiment

With the embodiment above, because there is the possibility that the density will fluctuate at the point where the unsaturated fluid flowing in the translucent duct 10 is trapped and at the point where the flow rate is measured, when the density of the unsaturated fluid is unstable, the correct flow volume cannot be measured. Further, there are many cases where the atomization rate does not stabilize and there has been the problem that it is difficult to estimate the exact density at the point where the exact flow rate is measured from the atomization rate. Therefore, in the second embodiment, the above problem is solved by measuring the density of the unsaturated fluid at the same time as measuring the flow rate of the unsaturated fluid flowing in the translucent duct 10.

In the present invention, laser light is irradiated by the semiconductor laser 21 onto the translucent duct 10 and the density of the unsaturated fluid can be measured in real time by using the laser light. For example, when oil particles that have been atomized in the air are an unsaturated fluid, because the optical properties of the air and oil particles differ, the density can be measured by observing the laser light that passes through the translucent duct 10. The air can be considered to transmit the light substantially without reflecting the light and it can be said that, when the density of the oil particles is low, the amount of transmitted laser light increases. On the other hand, because the oil particles are opaque, it can be said that the amount of transmitted laser light is attenuated when the density of the oil particles is high. In addition, because the oil particles have a high refractive index than that of air, it can be said that the amount of scattered light resulting from the laser light being reflected by the oil particles increases when the density of the oil particles is high.

In other words, because it can be said that there is an unambiguous relationship between the amount of transmitted laser light (attenuation amount), the scatter light amount, and the density of the gas particles, by pre-examining this relationship, it is possible to obtain the density of the corresponding oil particles from the amount of transmitted laser light or the scattered light amount during flow rate measurement. Further, for detecting the transmitted light amount, it is sufficient to install a light intensity sensor like that of the CCD line sensor 42 on the optical axis of the semiconductor laser 21 so that laser light penetrating the translucent duct 10 can be received. If the amount of transmitted light is obtained, the amount of attenuation of the laser light in the translucent duct 10 can be obtained from the amount of light that is output of the original laser light. Further, because the CCD line sensor 42 is displaced from the optical axis of the semiconductor laser 21, the amount of scattered light can be detected by using the output signal of the CCD line sensor 42 and there is no need to add a new device. Irrespective of the technique used, because the density can be specified with the same timing as the timing for measuring the flow rate, the exact flow volume can be measured even when the atomization rate and density or the like are unstable.

### (C) Third Embodiment

Generally speaking, in cases where a minute flow volume is generated, because the pressure difference is excessive when the actuators are driven continuously, the actuators are operated intermittently. In such cases, the flow of the fluid is extremely complicated depending on the drive timing of each actuator. That is, in addition to the flow rate fluctuating over time, depending on the case, there is sometimes a counter current. In such a case, if the flow state can be grasped visually in addition to numerical values referring to the flow rate and flow volume, it is possible to accurately grasp the flow state of a fluid of a minute flow volume.

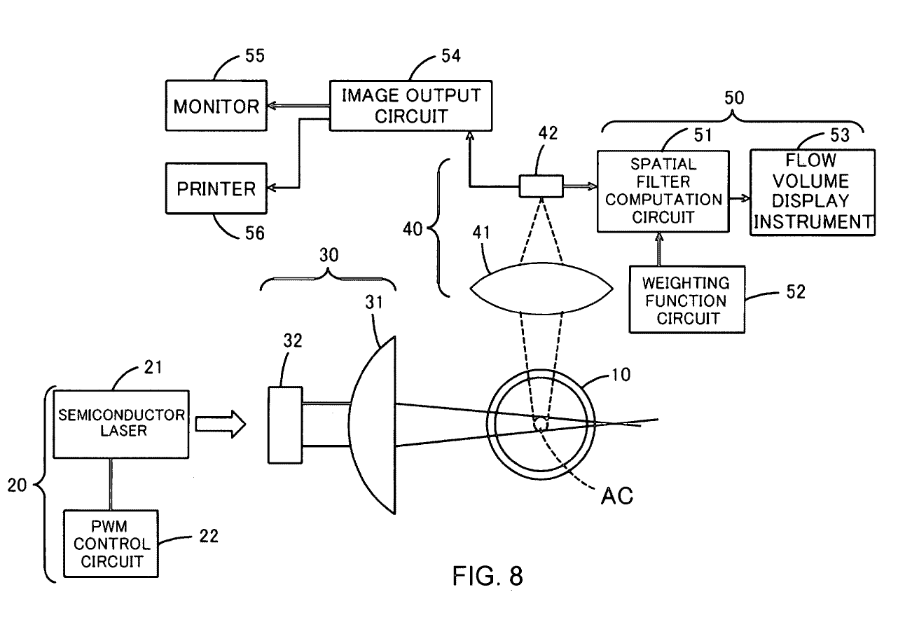

FIG. 8 shows an exemplary schematic constitution of a flow state observation device according to the third embodiment. In FIG. 8, an image output circuit 54 is additionally connected to the CCD line sensor 42 and the image output circuit 54 is connected to a monitor 55 and printer 56 that correspond to the output means of the present invention. As detailed earlier, the output signals of the CCD line sensor 42 signify the image pickup images of the axial core area of the translucent duct 10 and respective pixels that are arranged in a line shape are one-dimensional image data that have brightness levels that correspond with the reflection light amounts reflected by particles of different optical properties that exist in the corresponding positions. The CCD line sensor 42 outputs one-dimensional image pickup data to the image output circuit 54. The image output circuit 54 comprises a memory (not illustrated) and sequentially stores the image data. The image output circuit 54 then outputs image data to each of the monitor 55 and printer 56 on the basis of the sequentially stored image pickup image data.

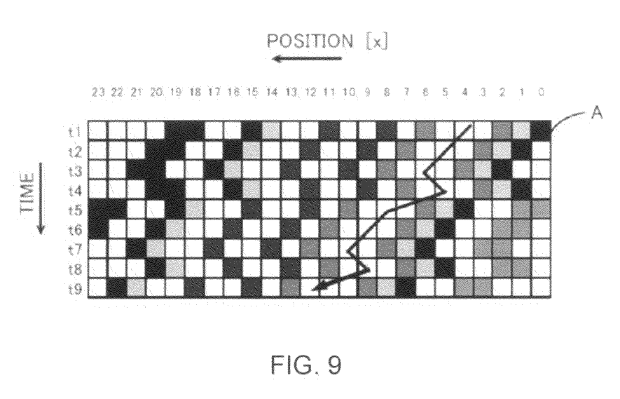

FIG. 9 shows a simplified example of an image that is output by the monitor 55 and printer 56. In FIG. 9, a rectangular image A is displayed; the vertical axis of image A represents time and the horizontal axis of image A represents the position (x) in the axial core direction of a pixel. Further, this means that, the lighter the pixel color is, the larger the light reception amount of the CCD element at the corresponding address and the thicker the pixel color is, the smaller the light reception amount of the CCD element at the corresponding address. FIG. 9 shows an exemplary simplified version of image A. In reality, an image at the resolution corresponding to the number of pixels of the CCD line sensor 42 is displayed.

In image A, one-dimensional images of the respective times that are sequentially output by the CCD line sensor 42 are arranged successively with time. In this kind of image A, when one time is considered, it is possible to visually grasp the fact that particles with different optical properties are distributed in particular positions in the axial core area of the translucent duct 10. In addition, by tracking dense pixels spanning a plurality of times, it is possible to visually grasp the positions of the particles with different optical properties as time elapses.

It can be seen from image A that particles with different optical properties move to the left in the axial core direction as time elapses. For example, when the locus of the dense pixels rises to the right, it can be said that particles with different optical properties are progressing from right to left at this time and, the smaller the gradient, the faster the flow rate is. Conversely, when the locus of the dense pixels falls to the right, it can be said that the particles with different optical properties are flowing in the reverse direction from left to right at this time. In FIG. 9, an aspect in which a fluid is temporarily flowing in the reverse direction is shown.

Further, because the frictional drag between the particles with different optical properties and the fluid medium is generally large, a plurality of particles with different optical properties are translated without there being a change in their position relative to one another. Thus, in the case of image A which is displayed such that image pickup images of a plurality of times can be compared, the flow state of the fluid in the translucent duct 10 can be visually grasped and it is easy to grasp the flow state even when same is complex. Therefore, optimization of the control timing and so forth of the actuator can also be performed. Further, in image A, the amounts of light received by the CCD elements may be expressed using gray scales or the image output circuit 54 may carry out binarization by applying a predetermined threshold value.

### (D) Fourth Embodiment

In the first embodiment, it was possible to measure the flow rate and flow volume and so forth with favorable responsiveness and specify an instantaneous flow rate and flow volume at the respective times. However, in the case of an intermittent flow as shown in image A of FIG. 9, there was the problem that the flow rate became unstable and ripples had an adverse effect on the instantaneous flow rates and flow volumes. In other words, in the case of an intermittent flow for which the flow rate is unstable, the average flow rate and flow volume over a long period is preferably calculated when grasping the flow state. For example, it may be said that it is more important to obtain the average flow rate from time t1 to time t5 than the flow rate from time t1 to time t2 in image A of FIG. 9 after considering the total amount of fluid supplied.

The average flow rate from time t1 to time t5 can be obtained by dividing the distance (number of pixels) that the particles with different optical properties have moved from time t1 to time t5 by the time from time t1 to time t5 and applying the optical imaging magnification of the CCD line sensor 42. The distance (number of pixels) that the particles with different optical properties have moved from time t1 to time t5 is specified using the translational properties of the particles with different optical properties. The technique for calculating the distance that the particles with different optical properties have moved from time t1 to time t5 will be explained hereinbelow.

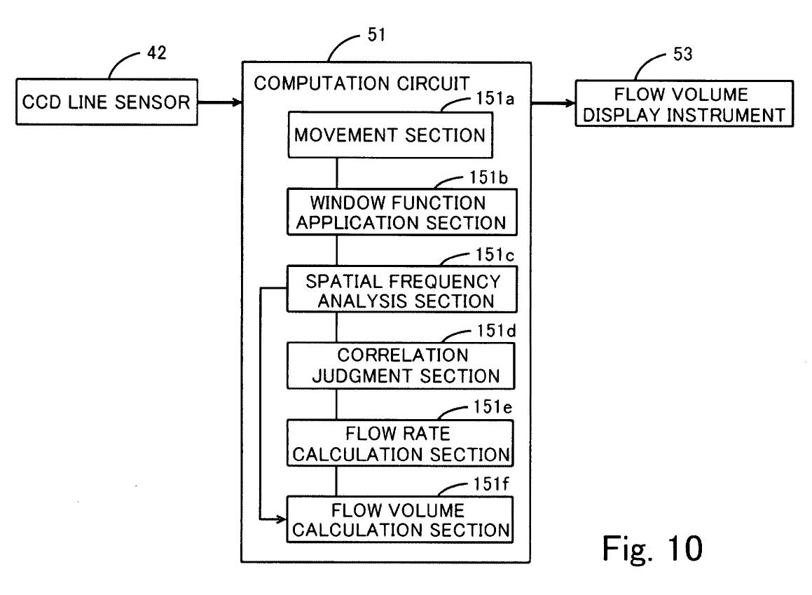

FIG. 10 shows an exemplary constitution for calculating the flow rate from the image pickup images picked up by the CCD line sensor 42. In FIG. 10, the computation circuit 51 obtains the image pickup images from the CCD line sensor 42. The computation circuit 151 replaces the spatial filter computation circuit 51 of the first embodiment and is constituted by a movement section 151a, a window function application section 151b, a spatial frequency analysis section 151c, a correlation judgment section 151d, a flow rate calculation section 151e, and a flow volume calculation section 151f. The movement section 151a, window function application section 151b, and spatial frequency analysis section 151c correspond to the spatial frequency analysis means of the present invention and the correlation judgment section 151d and flow rate calculation section 151e correspond to the flow rate calculation means of the present invention. First, the computation circuit 51 acquires the image pickup images picked up at different times and the image pickup times. For example, the computation circuit 51 acquires the respective image pickup images at times t1 and t5 in image A of FIG. 9.

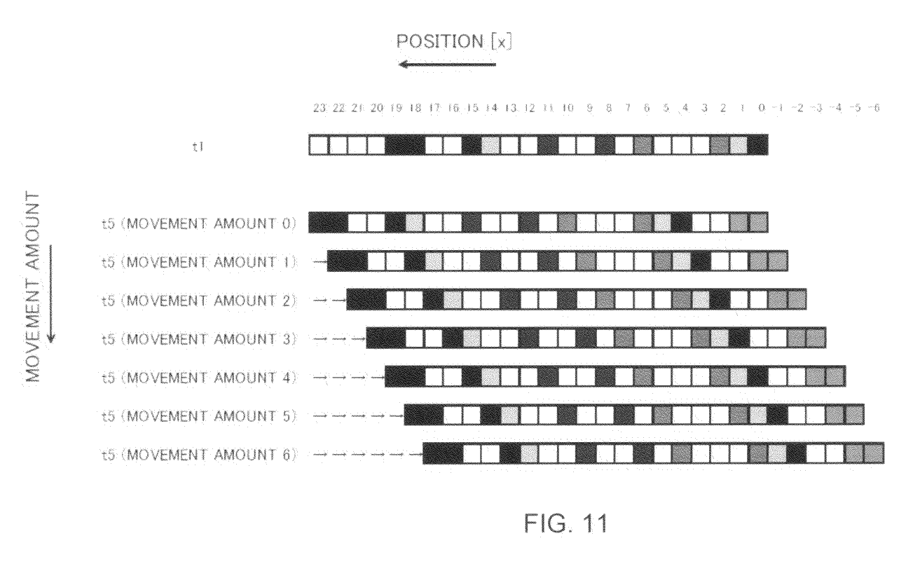

The movement section 151a shifts the image pickup images picked up at time t5 in the axial core direction. FIG. 11 schematically shows an exemplary aspect in which the movement section 151a shifts the image pickup images picked up at time t5 in the axial core direction. In FIG. 11, the image pickup images picked up at time t5 are shifted to the right of the page. In FIG. 11, image pickup images that have been moved with movement amounts of 0 to 6 pixels are illustrated. That is, when the movement amount is n pixels, the position x in the axial core direction of the horizontal axis is shifted to (x-n).

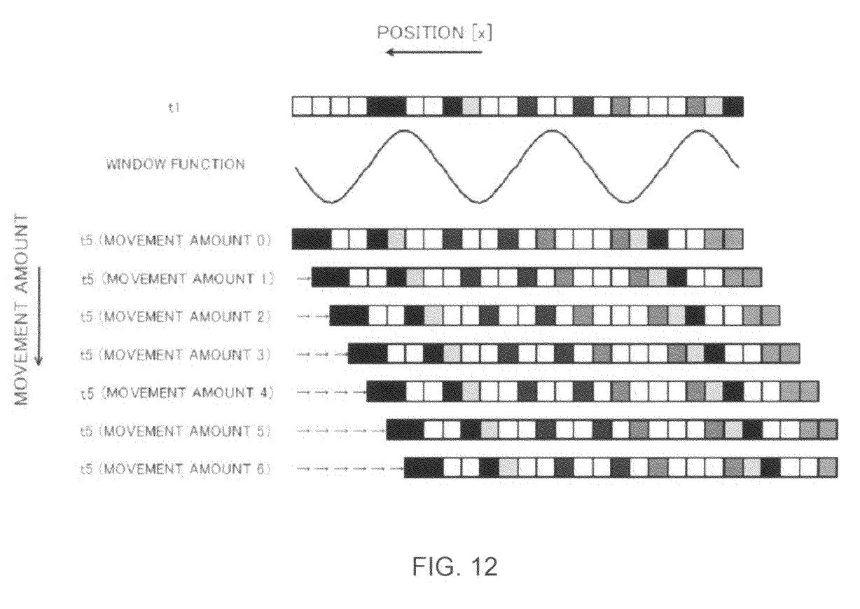

The window function application section 151b multiplies the image pickup images by a sine function as the window function. FIG. 12 shows an exemplary comparison between the window function and the respective pixel images. The window function M(x) shown in FIG. 12 can be expressed by the following equation:

In other words, the window function M(x) is an 8-pixel cycle sine wave. Further, the window function M(x) is only an example and can be suitably changed in accordance with the resolution and so forth of the CCD line sensor 42. The window function application section 151b multiplies the brightness B(x) of each pixel by the window function M(x). As a result, the brightness B(x) of each pixel is cyclically enhanced by the window function M(x).

The image pickup images picked up at time t5 is multiplied by the window function M(x) and an image pickup image enhanced by the window function M(x) is obtained. Likewise, the image pickup images picked up at time t5 that have been moved by the movement section 151a are also multiplied by the window function M(x), and enhanced image pickup images are obtained. However, because the image pickup images picked up at time t5 are moved by the movement section 151a, the relative phases in the axial core direction of the brightness B(x) and window function M(x) of each pixel are shifted and multiplied. Further, image pickup images and the window function M(x) for time t5 can also be moved relatively in the axial core direction and a plurality of window functions M(x) the initial phase angle of which is shifted may be prepared multiplied by the brightness B(x) of the respective pixels at time t5. Further, the image pickup images at times t1 and t5 may be moved relatively in the axial core direction or the image pickup images at time t5 may be fixed and the image pickup images at time t1 may be moved.

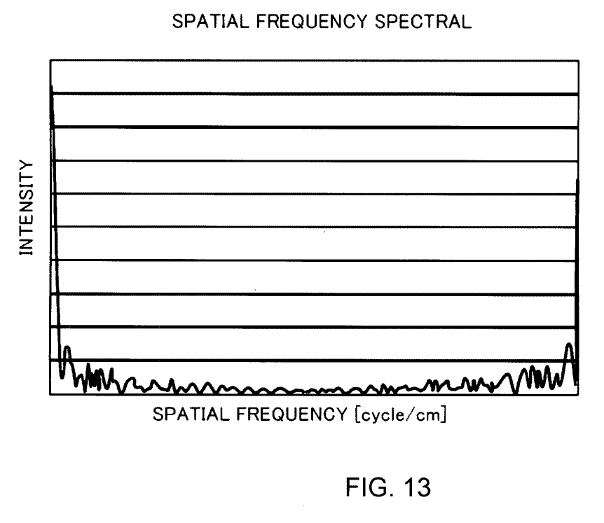

The spatial frequency analysis section 151c performs a high-speed Fourier transform (abbreviated as ‘FFT’ hereinbelow) with respect to image pickup images picked up at time t1 and enhanced by the window function M(x). FIG. 13 shows an exemplary spatial frequency spectral of the image pickup images at time t1 that was obtained by the FFT transform. In FIG. 13, the horizontal axis represents the spatial frequency f and the vertical axis represents the intensity (corresponds to an integrated value of the amplitudes of the respective luminance waves). Further, FIGS. 8 to 10 show a simplified version of the image pickup images. A variety of luminance waves can be sensed as shown in FIG. 13 at the actual resolution of the CCD line sensor 42.

The spatial frequency analysis section 151c performs an FFT transform on the respective image pickup images picked up at time t5 and enhanced by the window function M(x) the phase of which is displaced. As a result, a spatial frequency spectral can be obtained for the respective image pickup images picked up at time t5 and moved by 0 to 6 pixels. The correlation judgment section 151d evaluates the correlation between the spatial frequency spectral related to the image pickup images at time t1 and the spatial frequency spectral related to the respective image pickup images at time t5 (with movement amounts of 0 to 6 pixels). More specifically, the correlation coefficient W(XY) is calculated by means of the following equation:

In the above equation, f is the spatial frequency and * represents a complex product. Further, X(f) is the intensity of the spatial frequency spectral of the image pickup images picked up at time t1 and Y(f)* represents the conjugate of the intensity of the spatial frequency spectrals of the image pickup images picked up at time t5. Seven different correlation coefficients W(XY) are calculated using the equation above in correspondence with pixels of movement amounts 0 to 6. The correlation judgment section 151d detects the movement amount with the largest correlation coefficient W(XY) and outputs this movement amount to the flow rate calculation section 151e.

Here, the relative position of the window function M(x) fluctuates in accordance with the amounts by which the image pickup images picked up at time t5 are moved by the movement section 151a and spatial frequency spectrals of different inclinations are obtained in accordance with these movement amounts. Furthermore, because particles with different optical properties move to different positions as time elapses also for the image pickup images picked up at different times, a relative displacement with respect to the window function M(x) is produced and spatial frequency spectrals of essentially different inclinations are obtained. Hence, spatial frequency spectrals that are obtained from image pickup images picked up at times t1 and t5 also represent inclinations that are essentially different.

However, only in cases where the movement section 151a has moved the image pickup images at time t5 so that the distances by which the particles with different optical properties move between time t1 and time t5 cancel each other out, the positions in the axial core direction of the image pickup images of times t1 and t5 coincide and, as a result, the relative positions in the axial core direction with respect to the window function M(x) also coincide for both image pickup images. In this case, the spatial frequency spectrals obtained from the image pickup images of times t1 and t5 have the same inclination and represent a high correlation coefficient W(XY). FIG. 12 shows that, when the image pickup images picked up at time t5 have been moved by four pixels, movement is performed such that the distances by which the particles with different optical properties move between times t1 and t5 cancel each other out and the brightness B(x) of each pixel has been similarly enhanced by the window function M(x). The relative movement amount for which the correlation coefficient W(XY) is highest as described earlier can be said to correspond to the distance by which the particles with different optical properties have moved between times t1 and t5.

When the movement amount for which the correlation function W(XY) between the spatial frequency spectrals of the image pickup images picked up at different times is largest is specified, the flow rate calculation section 151 e that acquires this movement amount calculates the flow rate on the basis of the movement amount. As mentioned earlier, the movement amount for which the correlation function W(XY) is highest corresponds to the distance by which the particles with different optical properties have moved between times t1 and t5, the pixel movement amount per unit of time can be specified by dividing the distance by the time (t5−t1). Ultimately, the flow rate of the actual axial core can be obtained by dividing the pixel movement amount per unit of time by the optical imaging magnification m. As long as the flow rate of the axial core is obtained, the average flow rate can be calculated by means of the same technique as that of the first embodiment.

The average flow rate calculated by the flow rate calculation section 151e is output to the flow volume calculation section 151f. The flow volume calculation section 151f inputs the spatial frequency spectral of the image pickup images at time t1 from the spatial frequency analysis section 151c and calculates (integrates) the product sum of the intensity of the spatial frequency spectral with respect to the spatial frequency. As mentioned earlier, because the intensity of the spatial frequency spectral corresponds to the integrated value of the amplitudes of the respective luminance waves, the integrated value of the intensity is a value that corresponds to the scattered light amount that enters the CCD line sensor 42. That is, by integrating the intensity of the spatial frequency spectral, the total amount of scattered light entering the CCD line sensor 42 can be obtained.

As mentioned in the second embodiment, there is an unambiguous relationship between the scattered light amount scattered in the translucent duct 10 and the density of the unsaturated fluid flowing in the translucent duct 10. Hence, the flow volume calculation section 151f is able to estimate the density of the unsaturated fluid flowing in the translucent duct 10 by taking the integrated value of the intensity of the spatial frequency spectral as an index value. For example, the relationship between the integrated value of the intensity and the density of the unsaturated fluid is examined beforehand by means of an experiment, a table or the like is prepared, and the density of the unsaturated fluid can be estimated by referencing the table. As long as the density of the unsaturated fluid can be estimated, the average flow volume from time t1 to time t5 can be specified by multiplying the density by the average flow rate.

### (E) Summary

As described hereinabove, Based on the reality that even when a fluid is uniform and does not appear to produce scattered light, there are no fluids that are actually homogeneous and in which particles with different properties do not exist, when laser light is made to pass through a translucent duct and condensed to extend in the length direction in an axial core area of a predetermined region of the transmission path, image pickup can be performed by the CCD line sensor 42 as a result of scattered light being produced by particles with different properties in the axial core area and flow rate that uses a spatial filter can be computed by performing a predetermined operation. Moreover, the average flow rate and flow volume and so forth can be determined on the basis of the laminar flow in the translucent duct 10.

Although the invention has been described in considerable detail in language specific to structural features and or method acts, it is to be understood that the invention defined in the appended claims is not necessarily limited to the specific features or acts described. Rather, the specific features and acts are disclosed as preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. For example, the inductors can be hollow tubular coils. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in

What is claimed is:

1. A device for observing a flow state, comprising:
a translucent duct;
an irradiation unit irradiating projection light;
a condensing unit condensing the projection light along a length direction with respect to an axial core area of the translucent duct in which a fluid flows; and
an image pickup unit for picking up images of scattered reflected light from the axial core area of the translucent duct at a plurality of times.

2. A device for observing a flow state as set forth in claim 1, further comprising:
a computation unit for calculating a flow rate of the fluid on the basis of the image at the plurality of times.

3. A device for observing a flow state as set forth in claim 1, wherein:
the irradiation unit comprises a semiconductor laser and a Pulse Width Modulation (PWM) control circuit that controls an output of the semiconductor laser.

4. A device for observing a flow state as set forth in claim 1, wherein:
the image pickup unit comprises a Charge Coupled Device (CCD) line sensor.

5. A device for observing a flow state as set forth in claim 4, wherein:
a computation unit applies a spatial frequency filter to the image pickup images picked up by the CCD line sensor.

6. A device for observing a flow state as set forth in claim 4, wherein:
a computation unit multiplies a weighting function as a spatial frequency filter to outputs of the CCD line sensor.

7. A device for observing a flow state as set forth in claim 4, wherein:
a computation unit multiplies a sine function as a weighting function.

8. A device for observing a flow state as set forth in claim 4, wherein:
a computation unit multiplies a rectangular wave function as a weighting function.

9. A method for observing a flow state, comprising:
condensing projection light at an axial core area of a translucent duct; and
performing image pickup of the axial core area at a plurality of times.
